(19) United States
(12) Patent Application Publication
(10) Pub. No.: US 2013/0204644 A1
(43) Pub. Date: Aug. 8, 2013

(54) GENERATING AND EDITING CLAIMS PROCESSING RULES

(71) Applicants: JIM EVANS, CLEVELAND HEIGHTS, OH (US); CHRISTOPHER DOUBLEDAY, DOWNINGTOWN, PA (US); DIANE WARD, HIXSON, TN (US)

(72) Inventors: JIM EVANS, CLEVELAND HEIGHTS, OH (US); CHRISTOPHER DOUBLEDAY, DOWNINGTOWN, PA (US); DIANE WARD, HIXSON, TN (US)

(73) Assignee: MCKESSON FINANCIAL HOLDINGS, HAMILTON HM (BM)

(21) Appl. No.: 13/364,596

(22) Filed: Feb. 2, 2012

(51) Int. Cl. G06Q 40/08

(52) U.S. Cl. 705/4

(57) ABSTRACT

Systems, methods, apparatus, and computer program products are provided for processing claims. In various embodiments, claims can be processed and analyzed and used to generate new claims processing rules and/or edit existing claims processing rules.

### BACKGROUND

Generally, claims payment systems are very complex. For example, claims payment systems often process a high volume of claims in accordance with dynamic medical policies, payment policies, contract terms, and benefit plans. Such policies and terms may be poorly implemented by claims payment systems or even implemented via inflexible hard coding. Because claims volume can be so voluminous, a small misconfiguration can result in many claims that underpaid, overpaid, paid in duplicate, mispaid, or not paid. Thus, a need exists for creating new claims processing rules and editing existing claims processing rules to minimize and correct such misconfigurations.

### BRIEF SUMMARY

In general, embodiments of the present invention provide systems, methods, apparatus, and computer program products for processing claims.

In accordance with one aspect, a method for processing claims is provided. In one embodiment, the method comprises (1) processing a first set of one or more claims in accordance with one or more claims processing rules; (2) after processing the first set of one or more claims in accordance with the one or more claims processing rules, assigning a risk score to each processed claim, wherein the risk score indicates the risk level of the corresponding processed claim; and (3) categorizing at least one processed claim assigned a risk score above a configurable threshold as identifying a possible edit to the one or more claims processing rules. In one embodiment, the method may also comprise (4) receiving one or more edited claims processing rules, wherein the one or more edited claims processing rules comprises at least one edit to the one or more claims processing rules based at least in part on the at least one processed claim; and (5) processing a second set of one or more claims in accordance with the edited one or more claims processing rules.

In accordance with yet another aspect, a system comprising one or more processors and one or more memory storage areas is provided. In one embodiment, the system is configured to at least (1) process a first set of one or more claims in accordance with one or more claims processing rules; (2) after processing the first set of one or more claims in accordance with the one or more claims processing rules, assign a risk score to each processed claim, wherein the risk score indicates the risk level of the corresponding processed claim; and (3) categorize at least one processed claim assigned a risk score above a configurable threshold as identifying a possible edit to the one or more claims processing rules. In one embodiment, the system may also be configured to (4) receive one or more edited claims processing rules, wherein the one or more edited claims processing rules comprises at least one edit to the one or more claims processing rules based at least in part on the at least one processed claim; and (5) process a second set of one or more claims in accordance with the edited one or more claims processing rules.

In accordance with one aspect, a method for processing claims is provided. In one embodiment, the method comprises (1) processing a first set of one or more claims in accordance with one or more claims processing rules; (2) after processing the first set of one or more claims in accordance with the one or more claims processing rules, assigning a risk score to each processed claim, wherein the risk score indicates the risk level of the corresponding processed claim; (3) categorizing at least one processed claim assigned a risk score above a configurable threshold as possibly identifying at least one new claims processing rule; (4) receiving the at least one new claims processing rule, wherein the at least one new claims processing rule comprises based at least in part on the at least one processed claim; and (5) processing a second set of one or more claims in accordance with (a) the one or more claims processing rules and (b) the at least one new claims processing rule.

In accordance with yet another aspect, a system comprising one or more processors and one or more memory storage areas is provided. In one embodiment, the system is configured to at least (1) process a first set of one or more claims in accordance with one or more claims processing rules; (2) after processing the first set of one or more claims in accordance with the one or more claims processing rules, assign a risk score to each processed claim, wherein the risk score indicates the risk level of the corresponding processed claim; (3) categorize at least one processed claim assigned a risk score above a configurable threshold as possibly identifying at least one new claims processing rule; (4) receive the at least one new claims processing rule, wherein the at least one new claims processing rule comprises based at least in part on the at least one processed claim; and (5) process a second set of one or more claims in accordance with (a) the one or more claims processing rules and (b) the at least one new claims processing rule.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system according to various embodiments of the present invention.

FIG. 2 is an exemplary schematic diagram of a claims system according to one embodiment of the present invention.

FIG. 3 is a flowchart illustrating operations and processes that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. Exemplary System Architecture

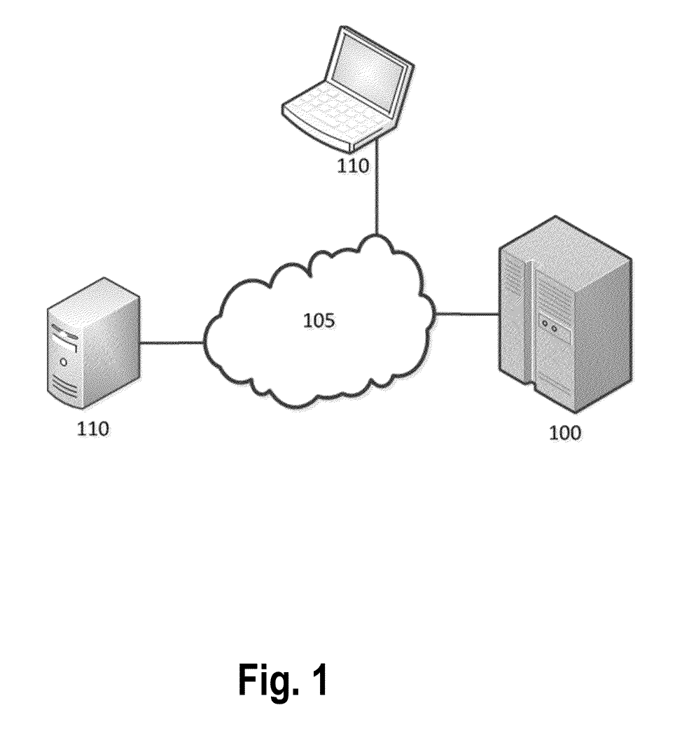

FIG. 1 provides an illustration of a system that can be used in conjunction with various embodiments of the present invention. As shown in FIG. 1, the system may include one or more claims systems 100, one or more networks 105, and one or more client/user computing entities 110. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates the various system entities as separate, standalone entities, the various embodiments are not limited to this particular architecture.

### 1. Exemplary Claims System

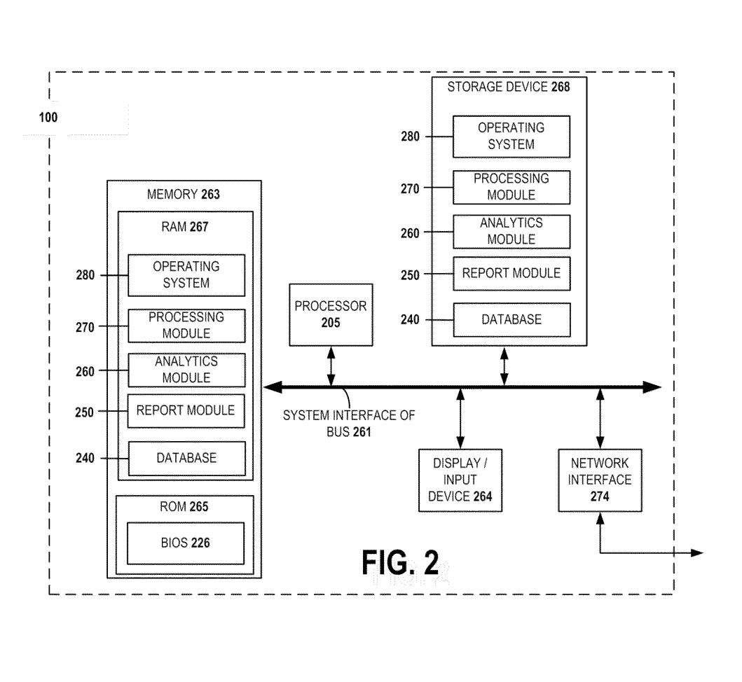

FIG. 2 provides a schematic of a claims system 100 according to one embodiment of the present invention. In general, the term “system” may refer to, for example, any computer, computing device, mobile phone, desktop, tablet, notebook or laptop, database management system, distributed system, server, blade, gateway, switch, processing device, or combination of processing devices adapted to perform the functions described herein.

As will be understood from FIG. 2, in one embodiment, the claims system 100 may include a processor 205 that communicates with other elements within the claims system 100 via a system interface or bus 261. The processor 205 may be embodied in a number of different ways. For example, the processor 205 may be embodied as a processing element, processing circuitry, a coprocessor, a controller or various other processing devices including integrated circuits such as, for example, an application specific integrated circuit (ASIC), a field programmable gate array (FPGA), a hardware accelerator, and/or the like.

In an exemplary embodiment, the processor 205 may be configured to execute instructions stored in memory or otherwise accessible to the processor 205. As such, whether configured by hardware or software methods, or by a combination thereof, the processor 205 may represent an entity capable of performing operations according to embodiments of the present invention when configured accordingly. For example, as discussed in more detail below, the claims system 100 may be configured, among other things, to process and analyze claims. A display/input device 264 for receiving and displaying data may also be included in (or in communication with) the claims system 100. This display device/input device 264 may be, for example, a keyboard or pointing device that is used in combination with a monitor (e.g., an electronic screen/display). The display/input device 264 may be a touchscreen that can detect the presence and location of a touch within the display area. The claims system 100 may further include transitory and non-transitory memory 263, which may include both random access memory (RAM) 267 and read only memory (ROM) 265. The claims system's ROM 265 may be used to store a basic input/output system (BIOS) 226 containing the basic routines that help to transfer information to the different elements within the claims system 100.

In addition, in one embodiment, the claims system 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, and/or the like. Additionally, each of these storage devices 268 may be connected to the system bus 261 by an appropriate interface.

Furthermore, a number of executable instructions, applications, scripts, program modules, and/or the like may be stored by the various storage devices 268 and/or within RAM 267. Such executable instructions, applications, scripts, program modules, and/or the like may include an operating system 280, a processing module 270, an analytics module 260, and a report module 250. As discussed in more detail below, these executable instructions, applications, program modules, and/or the like may control certain aspects of the operation of the claims system 100 with the assistance of the processor 205 and operating system 280—although their functionality need not be modularized. In addition to the program modules, the claims system 100 may store or be in communication with one or more databases, such as database 240 storing claims processing rules.

Also located within the claims system 100, in one embodiment, is a network interface 274 for interfacing with various computing entities, including a print computing entity. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the claims system 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the claims system's 100 components may be located remotely from other claims system 100 components. Furthermore, one or more of the components may be combined and additional components performing functions described herein may be included in the claims system 100.

### 2. Exemplary Client/User Computing Entity

In one embodiment, embodiments of the present invention may involve the use of one or more client/user computing entities 110. Generally, the term “computing entity” may refer to, for example, any computer, computing device, mobile phone, desktop, tablet, notebook or laptop, database management system, distributed system, server, blade, gateway, switch, processing device, or combination of processing devices adapted to perform the functions described herein. Accordingly, the client/user computing entity 110 may include components similar to those described with regard to the claims system 100. For example, the client/user computing entity 110 may comprise: (1) a processor that communicates with other elements via a system interface or bus; (2) a display device/input device; (3) memory including both ROM and RAM; (4) a storage device; and (5) a network interface. Similarly, a client/user computing entity 110 may comprise executable instructions, applications, scripts, program modules, and/or the like. As will be recognized, these architectures are provided for exemplary purposes only and are not limited to the various embodiments.

### III. Exemplary System Operation

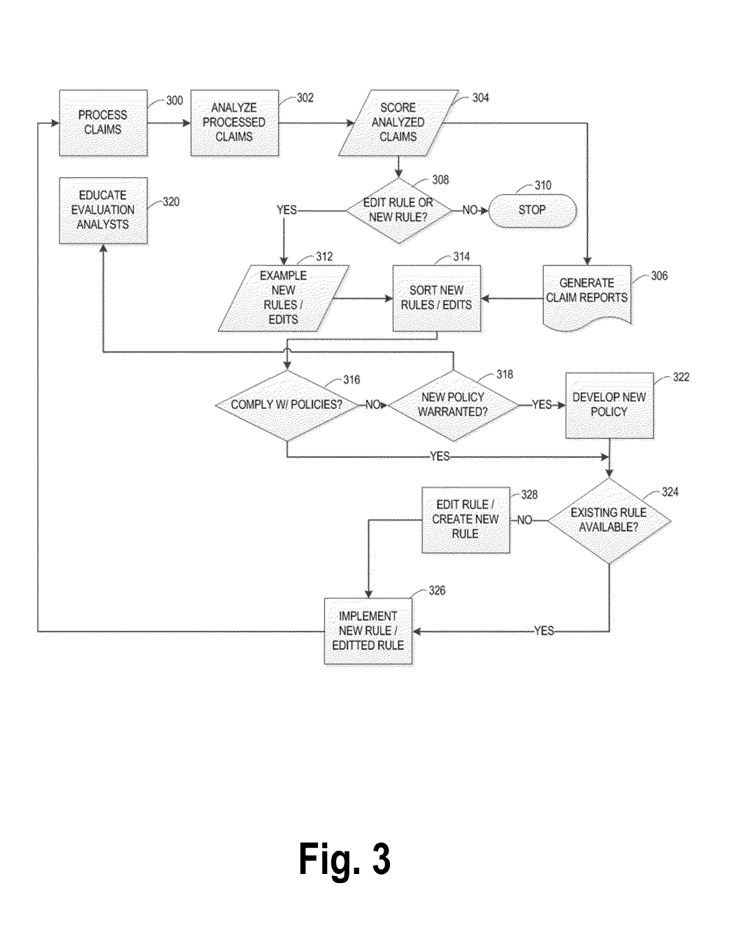

Reference will now be made to FIG. 3, which is a flowchart illustrating operations and processes that may be performed for processing claims. Generally, the operations and processes can use the processing of claims to edit existing claims processing rules and/or to create/generate new claims processing rules.

1. Claim Processing and Analysis with Claims Processing Rules

In one embodiment, the process may begin at Block 300 of FIG. 3, by the claims system 100 processing one or more claims, such as a first set of one or more claims. A claim may be a formal request for payment/reimbursement for services rendered and/or equipment provided. For example, a claim may be a request for payment for a consultation with a primary care doctor, a medical procedure performed by an orthopedic surgeon, a laboratory test performed by a laboratory, durable medical equipment provided to an injured patient, and/or the like. Each claim may therefore include one or more codes used for requesting payment/reimbursement, such as the Current Procedural Terminology (CPT) codes and/or Healthcare Common Procedure Coding System (HCPCS) codes. The codes may identify the services rendered and/or equipment provided.

In one embodiment, to process claims, various policies (e.g., claim policies) from health care providers, benefit plans, medical provider contracts, governmental guidelines or requirements may be applied to all processed claims or certain processed claims. Thus, a claim policy may be any policy that affects the payment of a claim. For instance, a provider claim policy may define the services that will be paid to a provider and how the provider will be paid. Similarly, the claim policies may define the services and equipment that are covered by a particular benefit plan, including deductibles, copays, frequency of visits, the time required between visits, the time required between treatments, gender, age, location, annual and lifetime maximum limits, and/or the like. Further, the claim policies may also define whether certain procedures are experimental, how medical and laboratory services and procedures should be coded for payment/reimbursement using, for example, the CPT or HCPCS codes. Thus, as will be understood, the claim policies may regularly change and be very complex.

In one embodiment, for actual application of the claim policies, claims processing rules can be created/generated for the enforcement of the policies in processing claims. As will be recognized, such claim policies being enforced may include provisions of a provider's contract, contracted payment amounts, covered services and equipment, copays, age limits, deductibles, and/or the like. In one embodiment, there may be a variety of claims processing rules and sets of claims processing rules. For example, there may be set of claims processing rules for each provider, for each benefit plan, for certain services and/or equipment, for certain codes, combinations thereof, and/or the like. In processing a claim, the claims system 100 (e.g., via the processing module 270) may apply the appropriate claims processing rules and create/generate an automated recommendation as to whether the claim should be paid, denied, and/or modified (e.g., recommended for payment in a manner other than as requested). As a result of the automated recommendation, a given claim may be paid, denied, modified, and/or reviewed further.

As indicated (Block 302 of FIG. 3), each processed claim may be reviewed further. For instance, the claims system 100 (e.g., via the analytics module 260) can analyze each claim that is processed. As part of the analysis, the claims system 100 (e.g., via the analytics module 260) can assign a risk score to each processed claim (Block 304 of FIG. 3). In one embodiment, such analysis of claims may involve the use of an unsupervised method for identifying norms in the data and then scoring the individual entities based on the degree to which they are similar or different from the data-driven norms. That is, the risk score can provide an indication of the risk level that the corresponding processed claim is inaccurate, fraudulent, wasteful, abusive, aberrant, and/or the like. For example, a low score may indicate the claim has a high degree of similarity to a data-driven norm. Similarly, a high score may indicate a low degree of similarity to a data-driven norm (i.e., indicating that it is highly likely that the claim is inaccurate, fraudulent, wasteful, abusive, aberrant, and/or the like).

In one embodiment, the range of risk scores can be arbitrarily created. For example, a range of risk scores may be whole numbers from 1 to 1,000. In this example, a risk score of 17 may indicate that it is extremely unlikely that the corresponding claim is inaccurate, fraudulent, wasteful, abusive, aberrant, and/or the like. Similarly, a risk score of 817 may indicate that it is extremely likely that the corresponding claim is inaccurate, fraudulent, wasteful, abusive, aberrant, and/or the like.

By way of example, if a claim were submitted for a compression stocking for $1,213.07 using billing code A6542, the claims system 100 (e.g., via the processing module 270) may process the claim in accordance with the appropriate claims processing rules. The claims system 100 may process the claim and create/generate an automated recommendation to pay the claim and re-price it at 80% of billed charges. Then, the claims system 100 (e.g., via the analytics module 260) may assign a risk score to the claim. In doing so, the claims system 100 (e.g., via the analytics module 260) may identify that this provider (and/or other providers) regularly bills compression stockings (using billing A6542) for abnormally high dollar amounts. Such billings could be due to intentional abuse by the providers and/or due to clerical errors in submitting the claims (such as entering a price for a case of compression stockings rather than individual compression stockings). Since the volume for compression stockings is high and a typical provider contract pays/reimburses providers based on a percentage of billed charges, the aggregate overpayments can be considerable. Thus, in such a case, the claims system 100 (e.g., via the analytics module 260) may assign a risk score of 713 to the claim—indicating that the likelihood of the claim being inaccurate, fraudulent, wasteful, abusive, aberrant, and/or the like is relatively high.

In another example, if a claim were submitted for preventative care for $494 using billing code 99395, the claims system 100 (e.g., via the processing module 270) may process the claim in accordance with the appropriate claims processing rules. The claims system 100 may process the claim and create/generate an automated recommendation to pay the claim. Then, the claims system 100 (e.g., via the analytics module 260) may assign a risk score to the claim. In doing so, the claims system 100 (e.g., via the analytics module 260) may identify that this provider (and/or other providers) is billing preventative care services (using billing code 99395) at abnormally high frequencies for individual health plan members. This may be because some providers who are capitated for office visits are billing preventative care services as non-capitated to increase their payment/reimbursement amounts. Thus, in such a case, the claims system 100 (e.g., via the analytics module 260) may assign a risk score of 804 to the claim indicating that the likelihood of the claim being inaccurate, fraudulent, wasteful, abusive, aberrant, and/or the like is relatively high.

In one embodiment, the claims system 100 (e.g., via the report module 250) can create/generate reports based on claim scores (Block 306 of FIG. 3). For example, the claims system 100 may create/generate a report grouping all compression stocking claims with a risk score above 250. In another example, the claims system 100 may create/generate a report for Dr. John Doe's claims over the past month, for preventative care services that Dr. Doe has provided during a certain time period, and/or Dr. Doe's claims with a risk score above 500. In various embodiments, such reports can be created/generated to aggregate high-scoring claims, which may be valuable in identifying certain concentrations of claims (large numbers or large amounts). This may lead to helping find where errors often occur around a particular procedure code, doctor, service, and/or the like.

In one embodiment, claims assigned a risk score above a configurable threshold (and/or =, ≧, <, ≦,), such as a threshold of risk scores ≧519 (or any other number), can be designated by the claims system 100 for first order of claim evaluation. In various embodiments, the value of the configurable threshold may vary to adjust and/or balance the workload of the computing entities handling the claim evaluation. The appropriate claims (e.g., based on risk score) can then be passed or assigned by the claims system 100 to a first order claims queue.

### 2. First Order of Claim Evaluation

In one embodiment, via the first order of claim evaluation, claims exceeding the configurable threshold can be categorized into (e.g., assigned to) one or more second order claims queues. For example, an appropriate computing entity (e.g., claims system 100, an intelligent client/user computing entity 110, a client/user computing entity 110 operated by an analyst, or other computing entity) can retrieve the appropriate claims exceeding the configurable threshold and categorize the claims into (e.g., assign to) one or more second order claims queues.

In one embodiment, a second order claims queue may correspond to the issue/reason that caused the corresponding claim to be assigned the risk score above the configurable threshold. Accordingly, there may be a second order claims queue (e.g., category) for claims identifying possible provider contract issues/reasons. There may be a second order claims queue (e.g., category) for claims identifying possible benefit plan issues/reasons, fraud issues/reasons, medical management issues/reasons, medical review issues/reasons, contracting issues/reasons, clinical risk management issues/reasons, and credentialing issues/reasons. Further, there may be a second order claims queue for claims identifying possible operations issues/reasons, provider audit issues/reasons, internal audit (process improvement or enforcement) issues/reasons, informatics issues/reasons, actuarial issues/reasons, disease/case management issues/reasons, SIU open case issues/reasons, medical policy issues/reasons, payment/reimbursement policy issues/reasons, and provider relations issues/reasons. In one embodiment, there may also be a second order claims queue (e.g., category) for claims identifying possible opportunities to edit one or more existing claims processing rules (Block 308 of FIG. 3). And, there may be a second order claims queue (e.g., category) for claims identifying possible opportunities to create/generate one or more new claims processing rules (Block 308 of FIG. 3).

Continuing with the above example, the claim processed for a compression stocking in the amount of $1,213.07 using billing code A6542 (risk score of 713) may be assigned to the second order claims queue (e.g., category) as identifying possible opportunities to edit one or more of the existing claims processing rules (such as modifying/adjusting a provider fee schedule). For instance, an appropriate computing entity (e.g., claims system 100, an intelligent client/user computing entity 110, a client/user computing entity 110 operated by an analyst, or other computing entity) may be used to determine that because claims for compression stockings are paid/reimbursed on a percentage of billed charges, claims submitted for high dollar amounts may result in substantial overpayment (the aggregate of which may be considerable). Thus, if such claims were only paid on a percentage of the amount of reasonable and customary, it could result in a savings of potentially hundreds of thousands to millions of dollars annually. Accordingly, this claim may be used to identify an opportunity to edit an existing rule claims processing rule (such as modifying/adjusting a provider fee schedule).

Similarly, the claim processed for preventative care for $494 using billing code 99395 may be assigned to the second order claims queue (e.g., category) identifying possible opportunities to create/generate one or more new claims processing rules. For instance, an appropriate computing entity (e.g., claims system 100, an intelligent client/user computing entity 110, a client/user computing entity 110 operated by an analyst, or other computing entity) may be used to determine that there is no automated payment policy in place for preventative care services. Thus, if a health plan resolved to develop and enforce a policy that only allows for preventative care services once every 12 months, it could result in a substantial savings to the health plan.

In one embodiment, in addition to assigning claims to one or more second order claims queues, an appropriate computing entity (e.g., claims system 100, an intelligent client/user computing entity 110, a client/user computing entity 110 operated by an analyst, or other computing entity) can attach one or more reports created/generated by the claims system 100. Similarly, the appropriate computing entity (e.g., claims system 100, an intelligent client/user computing entity 110, a client/user computing entity 110 operated by an analyst, or other computing entity) can attach notes, comments, codes, and/or the like related to the rationale for the categorization of the claim in the specific second order claims queue.

Further, in one embodiment, as part of the first order of claim evaluation, the appropriate computing entity (e.g., claims system 100, an intelligent client/user computing entity 110, a client/user computing entity 110 operated by an analyst, or other computing entity) may create/generate a recommendation as to whether a claim should be paid, denied, and/or modified. At this point, all or certain claims may then be paid, denied, and/or modified (Block 310 of FIG. 3). However, at least the claims identifying possible opportunities to edit one or more of the existing claims processing rules and/or identifying possible opportunities to create/generate one or more new claims processing rules proceed to the second order of claim evaluation.

### 3. Second Order of Claim Evaluation

In one embodiment, via the second order of claim evaluation, an appropriate computing entity (e.g., claims system 100, an intelligent client/user computing entity 110, a client/user computing entity 110 operated by an analyst, or other computing entity) can create/generate a recommendation to edit existing claims processing rules and/or create/generate a recommendation for new claims processing rules (Blocks 312, 314 of FIG. 3).

As indicated, as an example of an edit to an existing claims processing rule, an appropriate computing entity (e.g., claims system 100, an intelligent client/user computing entity 110, a client/user computing entity 110 operated by an analyst, or other computing entity) may be used to determine that because claims for compression stockings are paid/reimbursed on a percentage of billed charges, claims submitted for high dollar amounts may result in substantial overpayment (the aggregate of which may be considerable). Thus, if such claims were only paid on a percentage of the amount of reasonable and customary, it could result in a savings of potentially hundreds of thousands to millions of dollars annually. Accordingly, this claim may be used to identify an opportunity to reduce the amount that such claims should be paid with regard to the reasonable and customary amount by editing the claims processing rules. Then, an appropriate computing entity (e.g., claims system 100, an intelligent client/user computing entity 110, a client/user computing entity 110 operated by an analyst, or other computing entity) can be used to create/generate a recommendation to edit the existing claims processing rule. The recommendation to edit the existing claims processing rule may be to only pay a 70% of reasonable and customary for compression stockings claims. In one embodiment, such recommended edits to existing claims processing rules may include the information from the various reports and/or notes, comments, codes, and/or the like.

As an example of a new claims processing rule, an appropriate computing entity (e.g., claims system 100, an intelligent client/user computing entity 110, a client/user computing entity 110 operated by an analyst, or other computing entity) may be used to determine that there is no automated payment policy in place for preventative care. Thus, if a health plan resolved to develop and enforce a policy allowing preventative care services once every 12 months, it could result in a substantial savings to the health plan. Thus, an appropriate computing entity (e.g., claims system 100, an intelligent client/user computing entity 110, a client/user computing entity 110 operated by an analyst, or other computing entity) may be used to create/generate a recommendation for a new claims processing rule (and/or a new claim policy) for preventative care services. The recommendation to create/generate at least one new claims processing rule may be to only pay claims for preventative care services once every 12 months. In one embodiment, such recommendations for new claims processing rules may include the information from the various reports and/or notes, comments, codes, and/or the like.

In one embodiment, such recommended edits to claims processing rules and recommendations for new claims processing rules may be sorted and grouped together for aggregated consideration and/or evaluation (Block 314 of FIG. 3). Then, as indicated in Block 316, 318, and 322, an appropriate computing entity (e.g., claims system 100, an intelligent client/user computing entity 110, a client/user computing entity 110 operated by an analyst, or other computing entity) may be used to determine whether the recommendations to edit existing claims processing rules and/or create/generate new claims processing rules comply with existing claims policies, such as health care provider policies, benefit plan policies, medical provider contract policies, governmental policies, and/or the like. If such claims policies do not exist and are warranted, new claims policies may be developed. If such claims policies do exist, the claims processing rules can be created/generated, edited, and/or implemented in accordance with the recommendation. Further, evaluation team members can be educated with regard to any existing revised, edited, and/or new claims policies (Block 320 of FIG. 3).

As part of this process, an appropriate computing entity (e.g., claims system 100, an intelligent client/user computing entity 110, a client/user computing entity 110 operated by an analyst, or other computing entity) may be used to communicate with customer resources to assist in second order analysis. This may include documenting analysis results and recommendations of individual claims requiring customer action. Additionally, the appropriate computing entity (e.g., claims system 100, an intelligent client/user computing entity 110, a client/user computing entity 110 operated by an analyst, or other computing entity) may be used to re-assign and re-categorize claims to different second order claims queues if appropriate. The appropriate computing entity (e.g., claims system 100, an intelligent client/user computing entity 110, a client/user computing entity 110 operated by an analyst, or other computing entity) may also be used to create/generate queue management summary reports that summarize second order queue inventories and aging, provide analysis of second order queues, and/or outline rolling action plans.

Once one or more claims policies have been identified, edited, and/or developed based on the recommendations, the appropriate computing entity (e.g., claims system 100, an intelligent client/user computing entity 110, a client/user computing entity 110 operated by an analyst, or other computing entity) may be used to edit one or more existing claims processing rules and/or create/generate one or more new claims processing rules. In one embodiment, editing one or more existing claims processing rules and/or generating one or more new claims processing rules may simply require implementation of an existing claims processing rule that has yet to be implemented or yet to be implemented for certain providers, services, codes, and/or the like (Blocks 324, 326 of FIG. 3).

In another embodiment, editing one or more existing claims processing rules and/or generating one or more new claims processing rules may require proceeding through a rules editing and/or creation/generation process (Block 328 of FIG. 3). Such operations and processing may include passing existing claims processing rules through (or generating new claims processing rules via) a rules configurator, a rules dictionary, a rules specification, and/or the like.

Continuing with the above example, an existing claims processing rule for billing code A6542 may be edited to enforce new, existing, and/or revised claim policies that indicate that compression stockings for appendages are covered at 70% of the reasonable and customary amount of the compression stocking Similarly, a new claims processing rule for billing code 99395 may be created/generated to enforce new, existing, and/or revised claim policies that indicate that all preventative care services (whether capitated services or non-capitated services) are only covered once every 12 months.

4. Claim Processing with New and/or Edited Claims Processing Rules

In one embodiment, the edited claims processing rules and/or the new claims processing rules can be implemented for processing claims (Block 326 of FIG. 3). Generally, implementing edited claims processing rules and/or new claims processing rules means committing the claims processing rules. For example, the claims system 100 can store the edited claims processing rules and/or new claims processing rules and apply them to claims it processes, e.g., apply them to a second set of one or more claims.

By way of example, if a claim were submitted for a compression stocking in the amount of $1,023.07 using billing code A6542, the claims system 100 (e.g., via the processing module 270) may process the claim in accordance with the edited claims processing rules (Block 300 of FIG. 3). As previously described, in this example, the edited claims processing rules for billing code A6542 may enforce revised claim policies that indicate that compression stockings for appendages are covered at 70% of the reasonable and customary amount of the compression stocking Thus, in this example, the claims system 100 may process the claim and create/generate an automated recommendation to pay the claim in accordance with the revised rule (i.e., pay the claim at 70% of the reasonable and customary amount). As will be recognized, the claims system 100 (e.g., via the analytics module 260) may also assign a risk score and proceed with the first order and second order of claim evaluation as previously described—creating a potentially continuous feedback loop.

Similarly, a new claims processing rule for billing code 99395 may enforce new claim policies that indicate that all preventative care services (whether capitated services or non-capitated services) are only covered once every 12 months. Thus, the claims system 100 (e.g., via the processing module 270) may process the claims for billing code 99395 in accordance with the appropriate claims processing rules (including the new claims processing rule that only allows claims for preventative care services once every 12 months). As will be recognized, the claims system 100 (e.g., via the analytics module 260) may also assign a risk score and proceed with the first order and second order of claim evaluation for such claims as previously described—creating a potentially continuous feedback loop.

In various embodiments, such operations and processes may provide for the automated application of complex policies and terms to claims in real-time. They may also allow for the use of unsupervised analytics to identify previously unknown claims system weaknesses. To address such weakness, claims processing rules can be quickly developed and implemented in a continuous, repeatable process (e.g., a continuous feedback loop).

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for processing claims, the method comprising:
processing a first set of one or more claims in accordance with one or more claims processing rules;
after processing the first set of one or more claims in accordance with the one or more claims processing rules, assigning a risk score to each processed claim, wherein the risk score indicates the risk level of the corresponding processed claim;
categorizing at least one processed claim assigned a risk score above a configurable threshold as identifying a possible edit to the one or more claims processing rules;
receiving one or more edited claims processing rules, wherein the one or more edited claims processing rules comprises at least one edit to the one or more claims processing rules based at least in part on the at least one processed claim; and
processing a second set of one or more claims in accordance with the edited one or more claims processing rules.

2. The method of claim 1, wherein processing the first set of one or more claims comprises generating a recommendation for each processed claim for at least one of payment, denial, or modification.

3. The method of claim 1, wherein the one or more claims processing rules enforce one or more claim policies.

4. The method of claim 3 further comprising editing the one or more claims processing rules based at least in part on the at least one processed claim.

5. The method of claim 4 further comprising implementing the edited one or more claims processing rules.

6. A system comprising one or more processors and one or more memory storage areas, the system configured to:
process a first set of one or more claims in accordance with one or more claims processing rules;
after processing the first set of one or more claims in accordance with the one or more claims processing rules, assign a risk score to each processed claim, wherein the risk score indicates the risk level of the corresponding processed claim;
categorize at least one processed claim assigned a risk score above a configurable threshold as identifying a possible edit to the one or more claims processing rules;
receive one or more edited claims processing rules, wherein the one or more edited claims processing rules comprises at least one edit to the one or more claims processing rules based at least in part on the at least one processed claim; and
process a second set of one or more claims in accordance with the edited one or more claims processing rules.

7. The system of claim 6, wherein processing the first set of one or more claims comprises generating a recommendation for each processed claim for at least one of payment, denial, or modification.

8. The system of claim 6, wherein the one or more claims processing rules enforce one or more claim policies.

9. The system of claim 8, wherein the system is further configured to edit the one or more claims processing rules based at least in part on the at least one processed claim.

10. The system of claim 9, wherein the system is further configured to implement the edited one or more claims processing rules.

11. A method for processing claims, the method comprising:
processing a first set of one or more claims in accordance with one or more claims processing rules;
after processing the first set of one or more claims in accordance with the one or more claims processing rules, assigning a risk score to each processed claim, wherein the risk score indicates the risk level of the corresponding processed claim;
categorizing at least one processed claim assigned a risk score above a configurable threshold as possibly identifying at least one new claims processing rule;
receiving the at least one new claims processing rule, wherein the at least one new claims processing rule comprises based at least in part on the at least one processed claim; and
processing a second set of one or more claims in accordance with (a) the one or more claims processing rules and (b) the at least one new claims processing rule.

12. The method of claim 11, wherein processing the first set of one or more claims comprises generating a recommendation for each processed claim for at least one of payment, denial, or modification.

13. The method of claim 11, wherein the one or more claims processing rules enforce one or more claim policies.

14. The method of claim 13 further comprising generating the at least one new claims processing rule based at least in part on the at least one processed claim.

15. The method of claim 14 further comprising implementing the at least one new claims processing rule.

16. A system comprising one or more processors and one or more memory storage areas, the system configured to:
process a first set of one or more claims in accordance with one or more claims processing rules;
after processing the first set of one or more claims in accordance with the one or more claims processing rules, assign a risk score to each processed claim, wherein the risk score indicates the risk level of the corresponding processed claim;
categorize at least one processed claim assigned a risk score above a configurable threshold as possibly identifying at least one new claims processing rule;
receive the at least one new claims processing rule, wherein the at least one new claims processing rule comprises based at least in part on the at least one processed claim; and
process a second set of one or more claims in accordance with (a) the one or more claims processing rules and (b) the at least one new claims processing rule.

17. The system of claim 16, wherein processing the first set of one or more claims comprises generating a recommendation for each processed claim for at least one of payment, denial, or modification.

18. The system of claim 16, wherein the one or more claims processing rules enforce one or more claim policies.

19. The system of claim 18, wherein the system is further configured to generate the at least one new claims processing rule based at least in part on the at least one processed claim.

20. The system of claim 19, wherein the system is further configured to implement the at least one new claims processing rule.
